(19) United States
(12) Patent Application Publication
(10) Pub. No.: US 2025/0217655 A1
(43) Pub. Date: Jul. 3, 2025

(54) TRAINING METHOD AND APPLICATION METHOD OF NEURAL NETWORK MODEL, TRAINING APPARATUS AND APPLICATION APPARATUS OF NEURAL NETWORK MODEL, AND STORAGE MEDIUM

(71) Applicant: CANON KABUSHIKI KAISHA, Tokyo (JP)

(72) Inventors: Lingxiao Yin, Beijing (CN); Wei Tao, Beijing (CN); Tsewei Chen, Tokyo (JP); Dongyue Zhao, Beijing (CN); Siran Peng, Beijing (CN)

(21) Appl. No.: 19/000,204

(22) Filed: Dec. 23, 2024

(30) Foreign Application Priority Data
Dec. 29, 2023 (CN) 202311863264.5

(51) Int. Cl. G06N 3/084

(52) U.S. Cl. CPC G06N 3/084

(57) ABSTRACT

The present disclosure provides a training method for the neural network model including a calculation step of calculating importance of candidate operators in the neural network model with respect to accuracy of a network output based on a measurable indicator, wherein the candidate operators in the neural network model include at least one of a first type of operator including a learnable parameter or a second type of operator not including a learnable parameter; a selection step of selecting a candidate operator from the neural network model based on the importance of the candidate operators; and an update step of removing a selected candidate operator from the neural network model and adjusting a weight parameter in the neural network model to obtain an efficient neural network model, wherein the efficient neural network model is a neural network model in which a forward propagation process and a back propagation process are consecutive.

### CROSS REFERENCE TO RELATED APPLICATIONS

This application claims the benefit of Chinese Patent Application No. 202311863264.5 field on Dec. 29, 2023, the entirety of which is incorporated herein by reference.

### TECHNICAL FIELD

The present disclosure relates to the field of modeling of Deep Neural Networks (DNNs) models, in particular to a training method for multi-layer low-bit quantized neural network models.

### BACKGROUND

Deep neural network model is a model with complex network architecture in the field of artificial intelligence, and is also one of the most widely used architectures at present. Common neural network models include Convolutional Neural Network (CNN) models, etc. Deep neural network models are widely used in the fields of computer vision, computer hearing, and natural language processing, such as image classification, object recognition and tracking, image segmentation, and speech recognition. There are a large number of learnable parameters in the deep neural network models. The linear processing units and nonlinear processing units in the deep neural network models are connected crosswise, which results in a complicated topological relationship and is able to characterize any complex function. After a specific learning process, the deep neural network models can have powerful recognition and generalization capabilities.

Furthermore, running a deep neural network model requires a good deal of memory overhead and abundant processor resources. Although deep neural network model can achieve good performance on GPU-based workstations or servers, they are usually not for running on resource-limited embedded apparatus, such as smartphones, tablets, and various handheld devices.

To resolve the above problems, the following several solutions may typically be adopted to optimize the models:

Pruning/sparsity: in the process of training the network, unimportant connection relations are cut out, and most of the weights in the network become 0, so that the model is stored in a sparse mode. Pruning may be implemented at different levels, such as weight level, channel level, and layer level, depending upon the task.

Low-rank factorization: the low-rank factorization is performed using structured matrices, such that full-rank matrix which is originally dense can be expressed as a combination of several low-rank matrices, and the low-rank matrix may further be factorized into a product of small-scale matrices.

Quantization: a less bit width (1 bit, 2 bits or 8 bits) is used to represent a floating point number with 32-bit or more precision, so that the network parameters and the consecutive real values in a feature map are mapped onto discrete integer values to significantly reduce the storage space of parameters and memory footprint, speed up computation, and reduce the power consumption of the device.

Knowledge distillation: Unlike pruning and quantization in model compression, knowledge distillation is used to train a small model by constructing a lightweight small model and taking advantage of the supervisory information from a larger model with better performance in the hope of achieving better performance and accuracy. Specifically, the knowledge of a large network with good performance is transferred to a small network via transfer learning, so that the small network model achieves comparable performance to the large model, which could reduce the computational cost.

Design of a lightweight model architecture (compact model architecture): A specially structured network layer is constructed and trained from scratch to obtain network performance for deployment to resource-limited apparatus without a need for special storage of a pre-trained model or fine-tuning to improve the performance, which reduces the time cost and is featured in a small size of memory, low computational complexity, and good network performance.

Among the above-mentioned several technical schemes, design of compact model architectures has attracted widespread attention. In particular, the technique associated with models of the automatic search neural network model structures can not only significantly reduce the time cost of the design of the network structure, but also obtain a network model structure satisfying the specific constraints. However, due to the huge space of neural network model structures, the time and resource overhead of verifying the performance of all neural network model structures one by one is usually unbearable. Models of the automatic search neural network model structures are still difficult to realize despite the above advantages.

### SUMMARY

In order to resolve the problem of huge time and resource overhead for the model search described above, the PC-DARTS algorithm is discussed as a differentiable structure search method, which transforms the problem about discontinuous structure search into the problem about continuous structure parameter evolution. The specific method is to design corresponding structure parameters for the candidate network structure to be searched. The structure parameters are the parameters for estimating the importance of the corresponding candidate network structure, participate in the forward propagation process of the network in the form of weights, and are updated and optimized by a gradient optimization algorithm. Ultimately, the structure parameters and manually designed rules are utilized to deduce the searched network structure.

SPOS algorithm provides a two-stage search method for neural network model structure, which decouples a training process of the neural network and a searching process of the network model structure. The first stage is a process of optimizing the neural network model. Each sub-structure of the neural network model is constructed by a single-pathway method. When the parameters for the neural network model are optimized, only one of the pathways is activated and updated at a time. After the iterative optimization process, all subnetwork models in the search space are optimized simultaneously, and the weight parameters for the neural network are capable of approximately simulating the weight parameters obtained when each subnetwork is trained independently, which improves the accuracy of the validation set of the subnetwork model. Although the SPOS algorithm decouples the training process of the neural network and the searching process of the network model structure, the parameters between different subnetworks are still intercoupled among multiple iterations, which reduces the accuracy of the validation set of the subnetwork; under different application scenarios of the neural network model, there is a need for different searching processes, which reduces the search efficiency.

None of the technical solutions described above is able to gradually narrow the search space during the search and reduce the difficulty in the neural network model structure search. The estimated performance ranking of the network model obtained by the search is typically quite different from that of the network model after practical training, which reduces the efficiency and accuracy of automatic search for the neural network model structure.

According to one aspect of the present disclosure, there is provided a method for training a neural network model, comprising: a calculation step of calculating importance of candidate operators in the neural network model with respect to accuracy of a network output based on a measurable indicator, wherein the candidate operators in the neural network model include at least one of a first type of operator including a learnable parameter or a second type of operator not including a learnable parameter; a selection step of selecting a candidate operator from the neural network model based on the importance of the candidate operators; and an update step of removing a selected candidate operator from the neural network model and adjusting a weight parameter in the neural network model to obtain an efficient neural network model, wherein the efficient neural network model is a neural network model in which a forward propagation process and a back propagation process are consecutive.

According to another aspect of the present disclosure, there is provided an apparatus for training a neural network model, comprises: a calculation unit configured to calculate importance of candidate operators in the neural network model with respect to accuracy of a network output based on a measurable indicator, wherein the candidate operators in the neural network model include at least one of a first type of operator including a learnable parameter or a second type of operator not including a learnable parameter; a selection unit configured to select a candidate operator from the neural network model based on an importance indicator of the candidate operators; and an update unit configured to remove a selected candidate operator from the neural network model, and adjust a weight parameter in the neural network model to obtain an efficient neural network model, wherein the efficient neural network model is a neural network model in which a forward propagation process and a back propagation process are consecutive.

According to another aspect of the present disclosure, there is provided a method for applying a neural network model, comprising: storing a neural network model trained based on the method described above; receiving a dataset corresponding to a requirement of a task executable by the stored neural network model; and performing calculations on the dataset in each layer of the stored neural network model from top to bottom, and outputting a result.

According to another aspect of the present disclosure, there is provided an apparatus for applying a neural network model, comprising: a storage unit configured to store a neural network model trained based on the method described above; a receiving unit configured to receive a dataset corresponding to a requirement of a task executable by a stored neural network model; and a processing unit configured to perform calculations on the dataset in each layer of the stored neural network model from top to bottom, and output a result.

According to another aspect of the present disclosure, there is provided a non-transitory computer-readable storage medium storing instructions which cause, when executed by a computer, the computer to perform the method for training the neural network model described above.

The other features of the present disclosure will become apparent from the following description of the exemplary embodiments with reference to the attached drawings.

### BRIEF DESCRIPTION OF THE DRAWINGS

The drawings, which are incorporated in and constitute part of the specification, illustrate exemplary embodiments of the present disclosure and serve to explain, together with the descriptions on the exemplary embodiments, the principles of the present disclosure.

FIG. 1 shows a block diagram of a hardware configuration according to an exemplary embodiment of the present disclosure.

FIG. 2 shows a flowchart of a training method for a neural network model according to the first exemplary embodiment of the present disclosure.

FIG. 3 shows neural network model architecture.

FIG. 4 shows a flowchart of a training method for a neural network model according to the first exemplary embodiment of the present disclosure.

FIG. 5 shows a flowchart of a training method for a neural network model according to the first exemplary embodiment of the present disclosure.

FIG. 6 shows a schematic diagram of a training system according to the second exemplary embodiment of the present disclosure.

FIG. 7 shows a schematic diagram of a training apparatus according to the third exemplary embodiment of the present disclosure.

### DETAILED DESCRIPTION

Exemplary embodiments of the present disclosure will be described in detail with reference to the drawings. For the purpose of being clear and concise, the specification does not describe all features of the embodiments. However, it is appreciated that it is necessary to make numerous configurations specific to respective embodiments in implementation of the embodiments, so as to realize the specific objective of the developing personnel. For example, restrictions associated with device and business may be satisfied; and the restrictions may vary according to different embodiments. In addition, it is appreciated that although the development work may be very complicated and time costly, such development work is merely routine task for a person skilled in the art benefited from the contents of the present disclosure.

It should also be noted herein that in order to prevent causing ambiguity of the present disclosure with unnecessary details, the accompanying drawings only show the processing steps and/or system structures of close concern at least according to the solution of the present disclosure; other details less associated with the present disclosure are omitted.

### (Hardware Configuration)

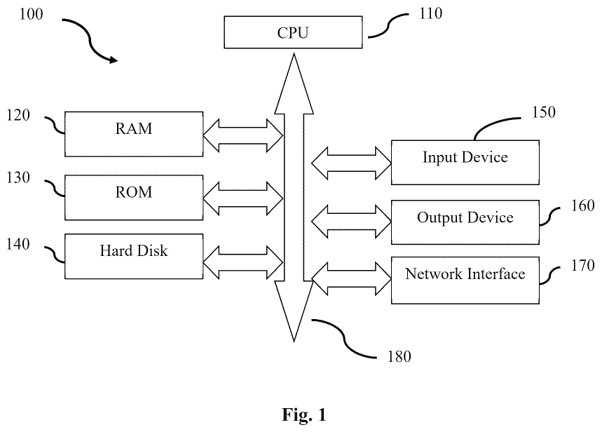

First, hardware configuration capable of implementing the techniques described subsequently is described with reference to FIG. 1.

The hardware configuration 100 includes, for example, a Central Processing Unit (CPU) 110, a Random Access Memory (RAM) 120, a Read-Only Memory (ROM) 130, a hard disk 140, an input device 150, an output device 160, a network interface 170, and a system bus 180. In an implementation, the hardware configuration 100 is implementable by a computer, such as a tablet computer, a laptop computer, a desktop computer, or other suitable electronic devices.

In an implementation, the apparatus for training a neural network model according to the present disclosure is constructed by hardware or firmware and serves as a unit or component of the hardware configuration 100. In another implementation, the method for training a neural network model according to the present disclosure is constructed by software stored in the ROM 130 or the hard disk 140 and executed by the CPU 110.

The CPU 110 is any suitable programmable control device (e.g. processor) and may execute various functions described subsequently by executing various applications stored in the ROM 130 or the hard disk 140 (e.g. memory). The RAM 120 is used to temporarily store program or data loaded from the ROM 130 or the hard disk 140 and also used as a space for the CPU 110 to execute various processes and other available functions. The hard disk 140 stores a variety of information such as an Operating System (OS), various applications, a control program, a sample image, a trained neural network model, and predefined data (e.g. thresholds, THs).

In an implementation, the input device 150 is configured to enable a user to interact with the hardware configuration 100. In an example, the user may input a sample image and a label of the sample image (e.g. region information of an object or category information of an object) via the input device 150. In a further instance, the user may trigger a corresponding process of the present disclosure via the input device 150. In addition, the input device 150 may take a variety of forms, such as a button, a keyboard, or a touch panel.

In an implementation, the output device 160 is configured to store a final trained neural network model into, for example, the hard disk 140 or to output the final trained neural network model to subsequent image processing such as object detection, object classification or image segmentation.

The network interface 170 provides an interface for connecting the hardware configuration 100 to the network. For example, the hardware configuration 100 may perform data communication via the network interface 170 with other electronic devices connected via the network. Optionally, a wireless interface may be provided for the hardware configuration 100 for wireless data communication. The system bus 180 may provide a data transmission path for mutual data transmission among the CPU 110, the RAM 120, the ROM 130, the hard disk 140, the input device 150, the output device 160, the network interface 170, etc. Though referred to as a bus, the system bus 180 is not limited to any specific data transmission technique.

The above-mentioned hardware configuration 100 is merely illustrative; it is not intended to limit the present disclosure or the application or use thereof. In addition, for the sake of conciseness, FIG. 1 illustrates only one hardware configuration. Nonetheless, multiple hardware configurations may be utilized as needed. Moreover, multiple hardware configurations may be connected via a network. In that case, the multiple hardware configurations may be implemented, for example, by a computer (e.g. cloud server) or by an embedded device, such as a camera, a video camera, a Personal Digital Assistant (PDA) or other suitable electronic devices.

Next, various aspects of the present disclosure are described.

### First Exemplary Embodiment

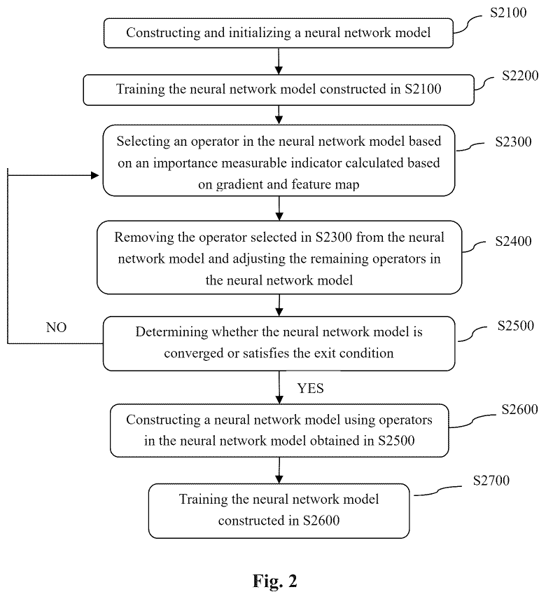

A training method for a neural network model according to the first exemplary embodiment of the present disclosure will be described hereinafter with reference to FIG. 2 through FIG. 5. The training method is described in detail below. The first embodiment shows the main workflow of neural network model structure search based on a gradient and a feature map according to the present disclosure.

Referring to FIG. 2, the training method is described in detail below.

Step S2100: constructing and initiating a neural network model.

Specifically, a neural network model is created based on the specific task requirement in this step. The neural network model possesses dense topological connections. The backbone network of the neural network model includes two basic structural blocks, which are a regular block and a descent block, respectively. In the regular block, the size of the input feature map is the same as that of the output feature map. In the descent block, if the stride of the first layer of convolution is set to 2, the width and height sizes of the input feature map are two times those of the output feature map, and other characteristics are the same as those of the regular block.

In the basic structural blocks of the neural network model, a node represents a feature map, and a connecting branch between the nodes represents an operator. The current node is obtained by fusing the information of all shallow nodes. The output feature map in the basic structural blocks is a sum or a concatenation result of all internal nodes.

The connecting branch between the nodes is composed of all operators in the search space, and the output of each branch is a sum of outputs of all operators on the branch. The operator is a set of functions that perform conversion of a feature map, and represents a calculation unit of the deep neural network model. The operator including a learnable parameter includes, but is not limited to, a convolution, a depthwise separable convolution, and a dilated convolution. The operator including no learnable parameter includes, but is not limited to, max pooling, average pooling, channel pooling, and channel shuffle.

Step S2200: training the neural network model constructed in S2100.

Training of a neural network model is a cyclic and repetitive process. Each of the iterations involves three processes: forward calculation, backward calculation, and parameter update. Forward calculation is to input a batch of data to be trained into the network, perform calculations layer by layer from top to bottom in the network model, and obtain the result of the network output. Backward calculation is a process of calculating the loss function based on the truth value of this batch of trained data and the result of the network output, and propagating the gradient of the loss function forward from the last layer of the network. Parameter update is mainly to calculate the updated value of the current parameter based on the back-propagated gradient value and the corresponding optimization algorithm. The neural network model is trained in this step until the network converges or the exit condition is satisfied.

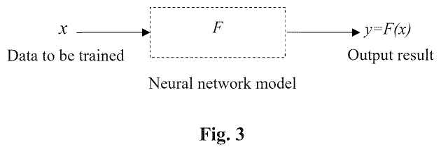

FIG. 3 shows a simple neural network model architecture (without showing the specific network architecture). After the data x (a feature map) to be trained is input into the neural network model F, x is calculated layer by layer from top to bottom in the neural network model F, and finally the output result y that satisfies certain distribution requirements is output from the neural network model F.

The training process of the neural network model is a cyclic and repetitive process, and each training involves three processes: forward propagation, back propagation, and parameter update. Forward propagation is a process of inputting the data x to be trained into the neural network model, and perform calculations on the data x layer by layer from top to bottom in the neural network model. The forward propagation process described herein may be a known forward propagation process. The forward propagation process may include a quantization process of feature maps and weights of any bit, which is not limited in the present disclosure. If the difference between the actual output result and the desired output result of the neural network model does not exceed the predetermined threshold, this indicates that the weight in the neural network model is optimal, and the performance of the trained neural network model has reached the desired performance. Training of the neural network model is therefore completed. Otherwise, if the difference between the actual output result and the desired output result of the neural network model exceeds the predetermined threshold, it is necessary to continue the back propagation process, that is, to perform calculations layer by layer from bottom to top in the neural network model based on the difference between the actual output result and the desired output result to update the weights in the model, so that the performance of the network model with the weights updated is closer to the desired performance.

The neural network model applicable to the present disclosure may be any known model, for example, a convolutional neural network model, a recurrent neural network model, and a graph neural network model. The present disclosure does not limit the type of the network model.

The computational accuracy of the neural network model applicable to the present disclosure may be any accuracy, either high accuracy or low accuracy. The term “high accuracy” and the term “low accuracy” refer to the relative levels of the accuracy and are not limited to the specific numerical values. For example, the high accuracy may be 32-bit floating-point type, and the low accuracy may be 1-bit fixed-point type. Of course, other accuracy such as 16-bit, 8-bit, 4-bit, and 2-bit accuracy is also included in the scope of computational accuracy applicable to the solution of the present disclosure. The term “computational accuracy” may refer to the accuracy of the weight in the neural network model or the accuracy of the feature map in the neural network model, which is not limited in the present disclosure. The neural network models according to the present disclosure may be Binary Neural Networks (BNNs) models, and are of course not limited to the neural network models with the other computational accuracy.

Step S2300: calculating importance of an operator in a neural network model based on a measurable indicator, and selecting the operator in the neural network model based on calculated importance.

The measurable indicator is calculated based on the information in the neural network model. The information includes the gradient information, the feature map information, the combined information of the feature map and gradient, and the parameter information in the neural network model. The measurable indicator calculated based on the gradient information includes single-shot network pruning (SNIP), gradient signal preservation (GRASP), synaptic flow pruning (SYNFLOW), and Jacobi determinant. The measurable indicator calculated based on the feature map information includes a scale factor of batch normalization and L2 norm. The measurable indicator calculated based on the combined information of the feature map and gradient includes Fisher information. The parameter information in the neural network model includes the scale factor in the normalization layer and the offset thereof, the weight of the filter and the offset thereof, etc.

The measurable indicator may not be normalized or may be normalized by the information including the number of floating-point operations, the number of multiply-accumulate operations, the total amount of memory consumption, the total amount of computational consumption, etc.

Importance indicator is a measurable indicator that characterizes the importance of an operator. In this exemplary embodiment, the importance indicator based on the gradient and feature map includes Fisher information, etc. The calculation formula of the Fisher information is as follows:

$$S ( f ) = {( \frac{\partial L}{\partial f} ⊙ f )}^{2} \qquad ( Formula 1 )$$

In the formula, L is an objective function and f is an output feature map corresponding to a certain operator. ∂L/∂f may be obtained in the back propagation process of the gradient without additional calculation. The operators in the difference set between the neural network model and the above deduced neural network model are ranked according to the importance scores calculated based on the gradients and feature maps, and the operator with the lowest importance is selected.

The algorithm by which the operator may be selected includes the greedy algorithm, the dynamic programming algorithm, the backtracking algorithm, the branch and bound algorithm, etc. In this step, a neural network model with dense topological connections is used without limiting the number and location of operators, thereby widening the search space.

Step S2400: removing the operator selected in step S2300 from the neural network model and fine-tuning parameters of remaining operators in the neural network model.

The operator selected in step S2300 is removed from the neural network model, and the neural network model from which the operator has been removed is used as an updated neural network model. The implementation method for removing the selected operator from the neural network model includes masking the output of this operator, removing the candidate operator from the neural network model and the like. Based on the task requirement and the training set data, the weight parameters in the neural network model are fine-tuned. In this embodiment, it is possible to update one of the backbone network, the feature pyramid network or the network head in the neural network model or a combination thereof.

Step S2500: repeating steps S2300 and S2400 until the neural network model updated in step S2400 satisfies the constraint condition. The constraint condition may be that the search is repeated more than a predetermined number of times.

Step S2600: constructing a neural network model using the operator in the neural network model obtained in step S2500.

The neural network model may be constructed by such manners as combining, stacking, and duplicating the operators in the neural network model obtained in step S2500. The newly constructed neural network model is the result of the neural network model search.

Step 2700: training the neural network model constructed in step S2600.

Based on the specific task requirement and the training set data, the neural network model constructed in step S2600 is trained until the network converges or the exit condition is satisfied.

With the solution of this exemplary embodiment, use of the neural network model with dense topological connections without limiting the number and location of the candidate operators to be selected broadens the search space, which allows for gradual search for a smaller network structure and yields a neural network model with better performance.

### Variation 1

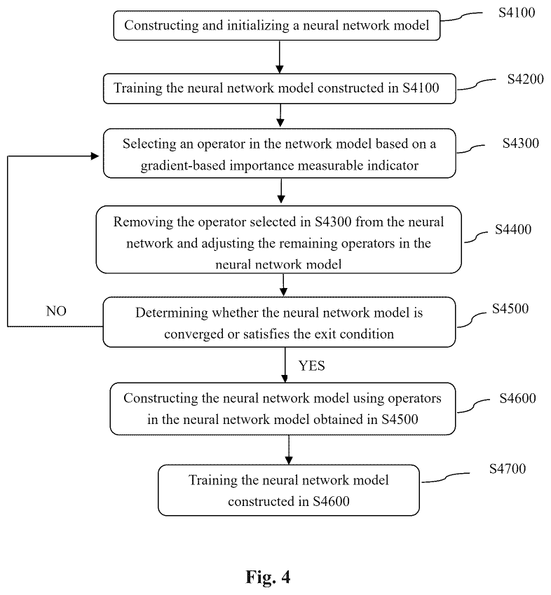

The training method for the neural network model in this exemplary embodiment will be described below with reference to FIG. 4. This exemplary embodiment shows the main workflow of updating the neural network model structure based on the gradient. The training method is described in detail below.

Step S4100: similar to step S2100, constructing and initiating a neural network model in this step.

Step S4200: similar to step S2200, training the neural network model constructed in S4100 in this step.

Step S4300: selecting an operator in the neural network model based on a gradient-based importance indicator.

In this exemplary embodiment, the importance indicator is a measurable indicator that characterizes the importance of the operator. The gradient-based importance indicator includes single-shot network pruning (SNIP), gradient signal preservation (GRASP), synaptic flow pruning (SYNFLOW), Jacobi determinant, etc. The calculation formula of the single-shot network pruning (SNIP) is as follows:

$$S ( θ ) = \vert \frac{\partial L}{\partial θ} ⊙ θ \vert \qquad ( Formula 2 )$$

The calculation formula of the gradient signal preservation (GRASP) is as follows:

$$S ( θ ) = - ( H \frac{\partial L}{\partial θ} ) ⊙ θ \qquad ( Formula 3 )$$

The calculation formula of the synaptic flow pruning (SYNFLOW) is as follows:

$$S ( θ ) = \frac{\partial L}{\partial θ} ⊙ θ \qquad ( Formula 4 )$$

In the above formulas, L is an objective function, θ is a learnable parameter in the operator, and H a Hessian matrix.

Based on the importance indicator of each of the operators as described above, it is possible to deduce a true subset of the neural network model structure with the highest importance score by the dynamic programming algorithm according to the set optimization goal. In this way, all the operators that are not within the subset are the operators that should be removed.

Step S4400: similar to step S2400, removing the operator selected in step S4300 from the neural network model and fine-tuning parameters for remaining operators in the neural network model in this step.

The operator selected in step S4300 is removed from the neural network model, and the neural network model from which the operator has been removed is used as an updated neural network model. Based on the task requirement and the training set data, the weight parameters in the neural network model are fine-tuned. In this embodiment, it is possible to update one of the backbone network, the feature pyramid network or the network head in the neural network model or a combination thereof.

Step S4500: similar to step S2500, repeating steps S4300 and S4400 until the neural network model updated in step S4400 satisfies the constraint condition in this step. The constraint condition may be that the accuracy of the updated neural network model decreases more than expected.

Step S4600: similar to step S2600, constructing a neural network model in this step using the operator in the neural network model obtained in step S4500.

The neural network model may be constructed by such manners as combining, stacking, and duplicating the operators in the neural network model obtained in S4500. The newly constructed neural network model is the result of the neural network model search.

Step 4700: similar to step S2700, training the neural network model constructed in S4600 in this step.

Based on the specific task requirement and the training set data, training the neural network model constructed in step S4600 until the network converges or the exit condition is satisfied.

The solution of this exemplary embodiment allows for rapid search for a smaller network structure while the output accuracy satisfies the predetermined requirements.

### Variation 2

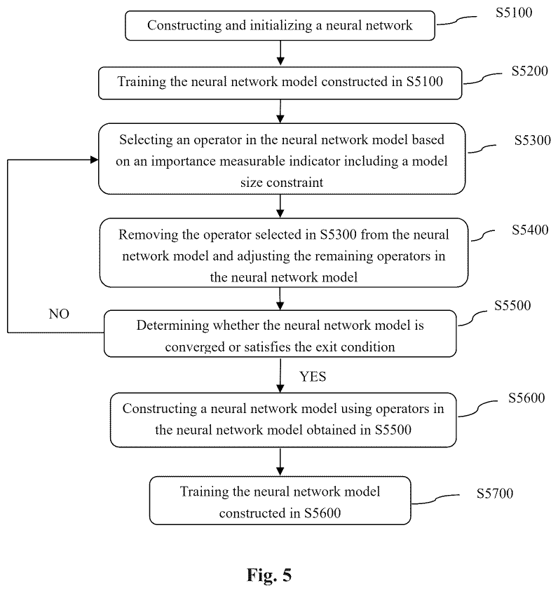

The training method for the neural network model according to this exemplary embodiment will be described below with reference to FIG. 5. This exemplary embodiment shows the main workflow of the neural network model structure search with both the accuracy and model size optimized. The training method is described in detail below.

Step S5100: similar to step S2100, constructing and initiating a neural network model in this step.

Step S5200: similar to step S2200, training the neural network model constructed in S5100 in this step.

Step S5300: selecting an operator in the neural network model based on a importance indicator containing a model size constraint.

The importance indicator is a measurable indicator that characterizes the importance of the operator. In this exemplary embodiment, the importance indicator includes Fisher information, single-shot network pruning (SNIP), gradient signal preservation (GRASP), synaptic flow pruning (SYNFLOW), Jacobi determinant, and a weighed combination thereof.

Depending upon the constraint of the network model size, a design is made to introduce a model size-based normalization factor to normalize the above-mentioned importance indicators. The normalization factor includes the number of floating-point operations, the number of multiply-accumulate operations, etc.

$$S = S / ( computational cost ) \qquad ( Formula 5 )$$

The operators in the difference set between the neural network model and the above deduced neural network model are ranked based on the importance scores after normalization, and the operator with the lowest importance after normalization is selected.

Step S5400: similar to step S2400, removing the operator selected in step S5300 from the neural network model and fine-tuning parameters for remaining operators in the neural network model.

The operator selected in step S5300 is removed from the neural network model, and the neural network model from which the operator has been removed is used as an updated neural network model. Based on the task requirement and the training set data, the weight parameters in the neural network model are fine-tuned. In this embodiment, it is possible to update one of the backbone network, the feature pyramid network or the network head in the neural network model or a combination thereof.

Step S5500: similar to step S2500, repeating steps S5300 and S5400 until the neural network model updated in step S5400 satisfies the constraint condition in this step. The constraint condition may be the one whether the size of the updated neural network model satisfies the predetermined requirement.

Step S5600: similar to step S2600, constructing a neural network model in this step based on the operator in the neural network model obtained in step S4500.

The neural network model may be constructed by such manners as combining, stacking, and duplicating the operators in the neural network model obtained in S5500. The newly constructed neural network model is the result of the neural network model search.

Step S700: similar to step S2700, training the neural network model constructed in S5600 in this step.

Based on the specific task requirement and the training set data, the neural network model constructed in step S5600 is trained until the network converges or the exit condition is satisfied.

According to this exemplary embodiment, it is possible to gradually search for the network structure that satisfies the size of the target model while keeping the accuracy as constant as possible.

Based on the solution of the exemplary embodiment of the present disclosure, first of all, the design requirements and the search space are specified according to the scenario, and the neural network model is defined. This model will include the model structures of all candidate networks in the search space and is an integrated model of all candidate network structures. Depending upon the objective of the task, the forward calculation and the backward gradient calculation are performed based on the training set and the labeled data. The gradient optimization algorithm is adopted to iteratively update the parameters of the neural network model until the network converges or the exit condition is satisfied.

Next, the weight parameters of the neural network model are inherited, and on the basis of their optimization results, the importance of each of the candidate operators in the neural network model is calculated based on the specified measurable indicator of the importance, and compared and ranked. The specified measurable indicator of the importance may measure the influence of each candidate operator on the overall performance of the neural network model. Based on the rank of the importance, the candidate operator having the least impact on the overall performance of the system is selected.

Finally, the system removes the selected candidate operators from the neural network, and the updated neural network will be used as a new neural network. The learnable parameters are fine-tuned based on the training set and the labeled data.

The above updating process is iterated until all the network structure models that can satisfy the task-related constraints are obtained.

Table 1 and Table 2 show the technical effects of the technical solution of the present disclosure with respect to the human face detection as compared to the prior art.

TABLE 1

| Larger Face Detection (FPPI = 0.01) | Accuracy |
|---|---|
| Manually Designed Model | 85.90% |
| PC-DARTS | 81.90% |
| Present Disclosure | 87.10% |

TABLE 2

| Smaller Face Detection (FPPI = 0.01) | Accuracy |
|---|---|
| Manually Designed Model | 63.90% |
| PC-DARTS | 77.40% |
| Present disclosure | 78.40% |

Table 3 and Table 4 show the technical effects of the technical solution of the present disclosure with respect to the human face feature point detection as compared to the prior art.

TABLE 3

| | Detection Accuracy of Larger Face in | | | |
|---|---|---|---|---|
| | Face-Up Direction | | | |
| | P = 3 | P = 4 | P = 5 | P = 6 |
| Manually Designed Model | 21.2 | 49.96 | 72.8 | 86.26 |
| PC-DARTS | 28.49 | 59.19 | 78.49 | 88.85 |
| Present Disclosure | 30.06 | 60.31 | 80.13 | 90.86 |

TABLE 4

| | Detection Accuracy of Smaller Face in | | | |
|---|---|---|---|---|
| | Face-Up Direction | | | |
| | P = 3 | P = 4 | P = 5 | P = 6 |
| Manually Designed Model | 3.26 | 5.51 | 14.17 | 24.6 |
| PC-DARTS | 3.88 | 6.8 | 16.32 | 26.81 |
| Present Disclosure | 4.29 | 7.54 | 18.93 | 32.82 |

*In the tables, P denotes the error (in pixels) of the feature point coordinate tolerated by the system.

As a result, the solution according to the exemplary embodiment of the present disclosure reduces the time and resource overhead spent in the neural network model structure search and improves the accuracy of the search result.

### Second Exemplary Embodiment

Based on the above-described first exemplary embodiment, the second exemplary embodiment of the present disclosure describes a network model training system, including a terminal, a communication network, and a server. The terminal and the server perform communication via the communication network. The server trains a network model stored in the terminal online with a network model stored locally, such that the terminal is capable of carrying out real-time businesses using the trained network model. Various parts of the training system according to the second exemplary embodiment of the present disclosure are described below.

The terminal in the training system may be an embedded image collection device such as a security camera, and may alternatively be a device such as a smartphone, a PAD, etc. Of course, the terminal may not be a terminal such as an embedded device of relatively low computational capabilities, but is other terminals of relatively high computational capabilities. The number of the terminals in the training system may be determined according to the actual needs. For instance, if the training system is for training security cameras in a shopping mall, all security cameras in the shopping mall may be deemed as terminals. In that case, the number of the terminals in the training system is fixed. For another instance, if the training system is for training smartphones of users in the shopping mall, all smartphones accessed to the wireless local network of the shopping mall may be deemed as terminals. In that case, the number of the terminals in the training system is not fixed. The second exemplary embodiment of the present disclosure does not limit the type and the number of the terminals in the training system as long as the terminal is capable of storing and training a network model.

The server in the training system may be a high-performance server of relatively high computational capabilities, such as a cloud server. The number of the server in the training system may be determined according to the number of terminals to be served. For example, if the number of terminals to be trained in the training system is relatively small or the geographical range in which the terminals are distributed is relatively small, the number of servers in the training system may be smaller; for example, there may be only one server. If the number of terminals to the trained in the training system is relatively great or the geographical range in which the terminals are distributed is relatively large, the number of servers in the training system may be greater; for example, a server cluster is established. The second exemplary embodiment of the present disclosure does not limit the type and the number of the server in the training system as long as the server is capable of storing at least one network model and providing information for training the network model stored in the terminal.

The communication network of the second exemplary embodiment of the present disclosure is wireless network or wired network realizing information transmission between the terminal and the server. All networks currently available in up/downlink transmission between network servers and terminals may be used as the communication network in this embodiment. The second exemplary embodiment of the present disclosure does not limit the type and the communication method of the communication network. Of course, the second exemplary embodiment of the present disclosure is not restricted to any other communication method. For example, a third-party storage region may be assigned to the training system. When information is to be transmitted by either of the terminal and the server to the other, the information to be transmitted is stored in the third-party storage region. The terminal and the server read information in the third-party storage region at regular times to realize information transmission therebetween.

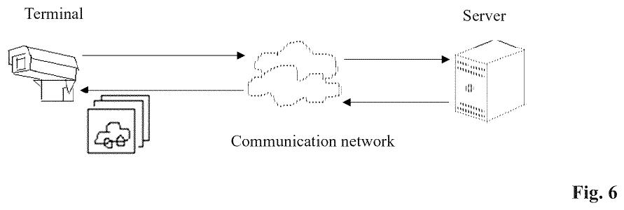

With reference to FIG. 6, the online training process of the training system according to the second exemplary embodiment of the present disclosure is described in details. FIG. 6 illustrates an example of the training system. The training system is assumed to include a terminal and a server. The terminal is capable of real-time photographing. It is assumed that the terminal stores a network model which can be trained and can process images, and the server stores the same network model. The training process of the training system is described below.

Step S201: the terminal initiates a training request to the server via the communication network.

The terminal initiates a training request to the server via the communication network. The request includes information such as a terminal identifier and the like. The terminal identifier is information uniquely representing the identity of the terminal (e.g., an ID or IP address of the terminal).

The above step S201 is explained with an example in which one terminal initiates the training request. Of course a plurality of terminals may initiate training requests in parallel. The processes of a plurality of terminals are similar to the process of one terminal, and are thus not redundantly described herein.

Step S202: the server receives the training request.

The training system shown in FIG. 6 includes only one server. Therefore, the communication network may transmit the training request initiated by the terminal to the server. If the training system includes a plurality of servers, the training request may be transmitted to a relatively idle server in view of the idleness of the servers.

Step S203: the server responds to the received training request.

The server determines the terminal initiating the request according to the terminal identifier included in the received training request, to determine the network model to be trained stored in the terminal. An option is that the server determines the network model to be trained stored in the terminal initiating the request according to a comparison table of the terminals and the network models to be trained. Another option is that the training request includes information of the network model to be trained, and the server may determine the network model to be trained according to the information. Here, determining the network model to be trained includes, but is not limited to, determining information characterizing the network model, such as a network architecture, a hyperparameter of the network model, and the like.

When the server determines the network model to be trained, the method of the first exemplary embodiment of the present disclosure may be used to train the network model stored in the terminal initiating the request using the same network model stored locally in the server. Specifically, according to step S2100 to step S2700 in the method of the first exemplary embodiment, the server updates the weights in the network model locally, and transmits the updated weights to the terminal so that the terminal synchronizes the network model to be trained stored in the terminal based on the received updated weights. Here, the network model in the server and the network model to be trained in the terminal may be the same network model; or the network model in the server may be more complicated than the network model in the terminal, but the two have close outputs. The present disclosure does not limit the type of the network model for training in the server and the network model to be trained in the terminal as long as the updated weights output from the server can make the network model in the terminal synchronized, such that the output by the synchronized network model in the terminal becomes closer to the expected output.

In the training system shown in FIG. 6, the terminal initiates the training request actively. Optionally, the second exemplary embodiment of the present disclosure is not limited to broadcasting inquiry information by the server and then responding to the inquiry information by the terminal for the above-described training process.

By the training system according to the second exemplary embodiment of the present disclosure, the server can train the network model in the terminal online, improving the flexibility of the training while greatly improving the capability of the terminal to handle businesses and expanding business handling scenarios of the terminal. In the second exemplary embodiment, the training system is described above with online training as an example. However, the present disclosure is not limited to the offline training process, which is not redundantly described herein.

### Third Exemplary Embodiment

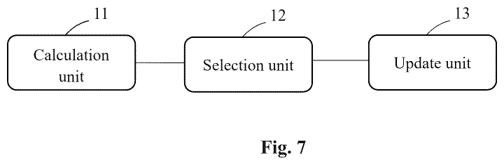

The third exemplary embodiment of the present disclosure describes a training apparatus for a neural network model. The apparatus can execute the training method described in the first exemplary embodiment. Moreover, when applied to an online training system, the apparatus may be an apparatus in the server described in the second exemplary embodiment. The software structure of the apparatus will be described in detail below with reference to FIG. 7.

The training apparatus in the present third exemplary embodiment includes a calculation unit 11, a selection unit 12, and an update unit 13. The calculation unit 11 is configured to calculate the importance of the candidate operator in the neural network model based on the measurable indicator, wherein the candidate operator in the neural network model at least includes a first type of operator including a learnable parameter and a second type of operator including no learnable parameter. The selection unit 12 is configured to select the candidate operator from the neural network model based on the importance indicator of the candidate operator. The update unit 13 is configured to remove the selected candidate operator from the neural network model, and adjust the weight parameters for the remaining candidate operators in the neural network model.

The training apparatus of this embodiment further includes units for realizing the functions of the server in the training system, such as the functions of identifying received data, data packaging, network communication, etc., which are not redundantly described herein.

### OTHER EMBODIMENTS

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The embodiments of the present disclosure may further be implemented by a method of providing the software (program) that executes the functions of the above-mentioned embodiments to a system or device via a network or various storage media, where a computer or a Central Processing Unit (CPU) or a microprocessor unit (MPU) of this system or device reads out and executes the program.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

What is claimed is:

1. A method for training a neural network model, comprising:
calculating an importance of candidate operators in the neural network model with respect to accuracy of a network output based on a measurable indicator, wherein the candidate operators in the neural network model include at least one of a first type of operator including a learnable parameter or a second type of operator not including a learnable parameter;
selecting a candidate operator from the neural network model based on the importance of the candidate operators; and
updating by removing a selected candidate operator from the neural network model and adjusting a weight parameter in the neural network model to obtain an efficient neural network model,
wherein the efficient neural network model is a neural network model in which a forward propagation process and a back propagation process are consecutive.

2. The method according to claim 1, further comprising
updating the neural network model by combining, stacking, or duplicating remaining candidate operators into the updated neural network model.

3. The method according to claim 1, wherein the step of updating further includes updating at least one of a backbone network, a feature pyramid network, or a network head in the neural network model.

4. The method according to claim 1, wherein the candidate operators are a set of functions that perform conversion of a feature map, and are calculation units in a deep neural network model, wherein the first type of operator comprises a convolution, a depthwise separable convolution, or a dilated convolution, and the second type of operator comprises max pooling, average pooling, channel pooling, or channel shuffle.

5. The method according to claim 1, wherein the measurable indicator is calculated based on information in the neural network model.

6. The method according to claim 1, wherein the step of selecting is executed based on an algorithm including one or more of a sorting algorithm, a greedy algorithm, a dynamic programming algorithm, a backtracking algorithm, or a branch and bound algorithm.

7. The method according to claim 1, wherein the measurable indicator is updated as the neural network model is updated.

8. The method according to claim 1, wherein removing the selected candidate operator from the neural network model comprises masking an output of the operator and deleting the candidate operator from the neural network model.

9. The method according to claim 5, wherein the measurable indicator is not normalized or is normalized by information including a number of floating-point operations, a number of multiply-accumulate operations, a total amount of memory consumption, or a total amount of computation consumption.

10. The method according to claim 5, wherein the information includes gradient information, feature map information, combined information of a gradient and a feature map, and parameter information in the neural network model.

11. The method according to claim 10, wherein the measurable indicator calculated based on the gradient information includes single-shot network pruning (SNIP), gradient signal preservation (GRASP), synaptic flow pruning (SYNFLOW), or a Jacobi determinant; the measurable indicator calculated based on the feature map information includes a scale factor of batch normalization and a L2 norm; and the measurable indicator calculated based on the combined information of the feature map and the gradient includes Fisher information.

12. The method according to claim 10, wherein the parameter information in the neural network model includes a scale factor in a normalization layer and an offset thereof, and a weight of a filter and an offset thereof.

13. An apparatus for training a neural network model, comprising:
at least one memory storing instructions; and
at least one processor that, upon executing the stored instructions, is configured to operate as:
a calculation unit configured to calculate importance of candidate operators in the neural network model with respect to accuracy of a network output based on a measurable indicator, wherein the candidate operators in the neural network model include at least one of a first type of operator including a learnable parameter or a second type of operator not including a learnable parameter;
a selection unit configured to select a candidate operator from the neural network model based on an importance indicator of the candidate operators; and
an update unit configured to remove a selected candidate operator from the neural network model, and adjust a weight parameter in the neural network model to obtain an efficient neural network model,
wherein the efficient neural network model is a neural network model in which a forward propagation process and a back propagation process are consecutive.

14. A method for applying a neural network model, comprising:
storing a neural network model trained by;
receiving a dataset corresponding to a requirement of a task executable by the stored neural network model; and
performing calculations on the dataset in each layer of the stored neural network model from top to bottom, and outputting a result.

15. An apparatus for applying a neural network model, comprising:
a storage unit configured to store a neural network model trained;
a receiving unit configured to receive a dataset corresponding to a requirement of a task executable by a stored neural network model; and
a processing unit configured to perform calculations on the dataset in each layer of the stored neural network model from top to bottom, and output a result.

16. A non-transitory computer-readable storage medium storing instructions which, when executed by a computer, cause the computer to perform the method for training the neural network model including.
